(19) United States
(12) Patent Application Publication
(10) Pub. No.: US 2014/0145951 A1
(43) Pub. Date: May 29, 2014

(54) DISPLAY DEVICE AND CURSOR CONTROLLING METHOD THEREOF

(71) Applicant: HON HAI PRECISION INDUSTRY CO., LTD., New Taipei (TW)

(72) Inventors: KUO-SHU HUNG, New Taipei (TW); TAI-MING LU, New Taipei (TW)

(73) Assignee: HON HAI PRECISION INDUSTRY CO., LTD., New Taipei (TW)

(21) Appl. No.: 14/065,631

(22) Filed: Oct. 29, 2013

(30) Foreign Application Priority Data
Nov. 29, 2012 (TW) 101144676

(51) Int. Cl. G06F 3/03

(52) U.S. Cl. CPC G06F 3/0304
USPC 345/158

(57) ABSTRACT

A display device controlled by a remote control includes an image capture device and a display screen. A remote control of the display device emits light using a light-emitting element, and real-time images of the remote control are captured during the time when the light-emitting element emits light. The captured images are analyzed to calculate a horizontal movement and a vertical movement of the light-emitting element. The display device controls movements of a cursor displayed on the display screen according to horizontal movement and a vertical movement of the light-emitting element.

### BACKGROUND

1. Technical Field

Embodiments of the present disclosure relate generally to display devices, and particularly to a cursor controlling method of a display device.

2. Description of Related Art

Controlling television (TV) sets using a remote control is well known in the art. For example, a user can control a TV set to switch from one channel to another channel by pressing buttons of the remote control. TV sets, such as digital TV, high definition TV, and network TV, can order online programs according to user requirements. A user can use the buttons arranged on the remote control to move a cursor displayed on the TV set, thereby controlling the TV set to perform corresponding functions. However, moving the cursor using the buttons of the remote control is inconvenient. Therefore, there is room for improvement in the art.

### BRIEF DESCRIPTION OF THE DRAWINGS

FIG. 1 is a schematic view of an exemplary embodiment of a display device.

FIG. 2 is a schematic block diagram of the display device of FIG. 1 including a plurality of functional modules.

FIG. 3 is flowchart of one embodiment of a cursor controlling method implemented by the display device of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one”. The reference “a plurality of” means “at least two”.

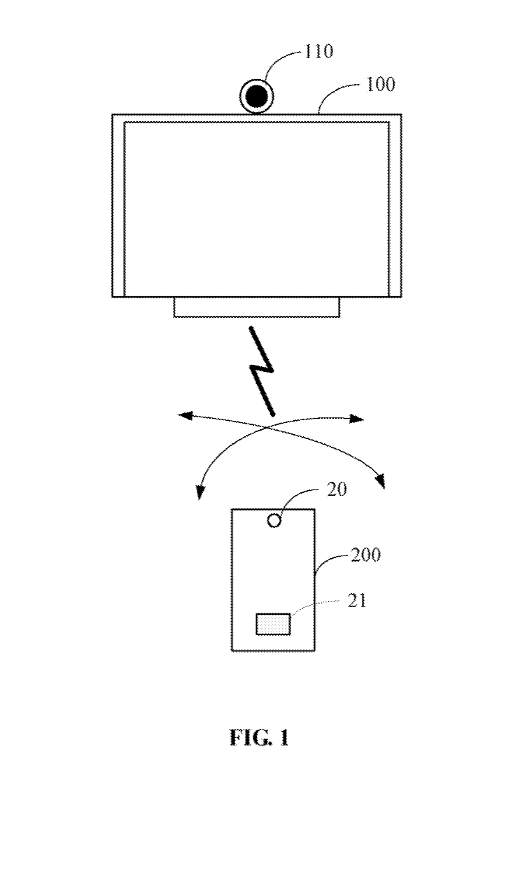

FIG. 1 is a schematic is a schematic view of an exemplary embodiment of a display device 100. The display device 100 may be, for example, a high definition television (HDTV), a digital TV, a network TV, a display of a computer, or other similar devices. The display device 100 is capable of being controlled by a remote control 200, and executes corresponding functions (e.g., channel change and volume adjustment) according to control signals sent form the remote control 200. The display device 100 includes an image capturing device 110 that is configured to capture images. The remote control 200 includes a light-emitting element 20, which is configured to emit near-infrared rays or other visible rays. The rays emitted by the light-emitting element 200 can be captured by the image capturing device 110.

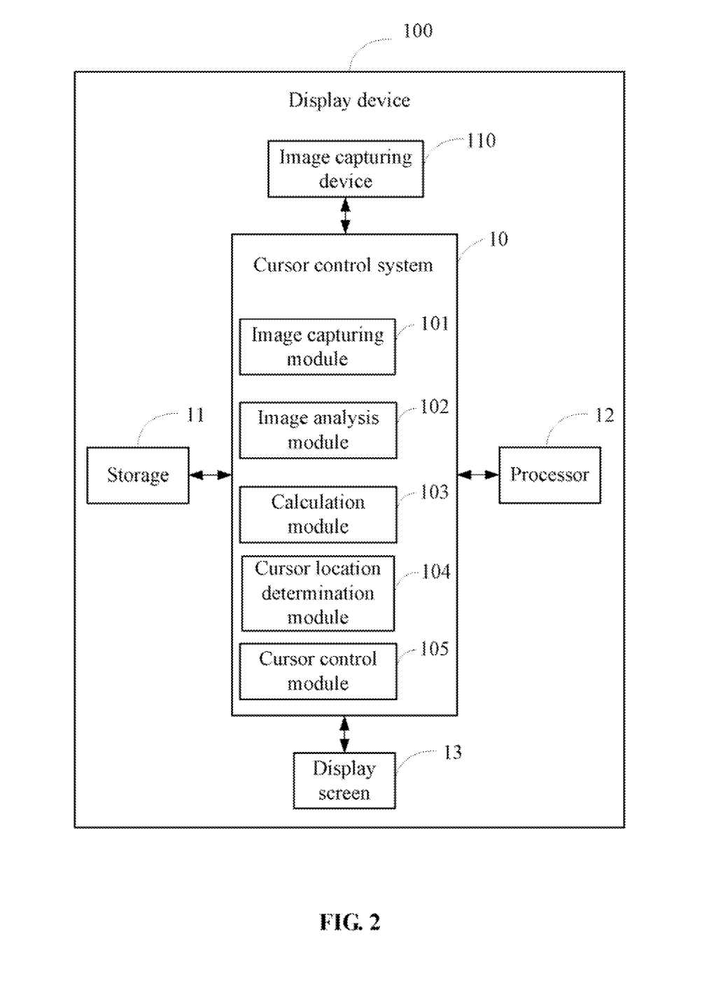

FIG. 2 is a schematic block diagram of the display device 100 of FIG. 1. The display device 100 further includes a cursor control system 10, a storage 11, and a processor 12 and a display screen 13. When the display device 100 is controlled by the remote control 200, a cursor is displayed on the display screen 13. In the embodiment, a cursor control button 21 is arranged on the remote control 200. When the cursor control button 21 is pressed, the cursor is displayed on the display screen 13, and the light-emitting element 20 continuously emits light. The cursor control system 10 detects movement of the light-emitting element 20 to control movement of the cursor on the display screen 13.

In this embodiment, the cursor control system 10 includes an image capturing module 101, an image analysis module 102, a calculation module 103, a cursor location determination module 104, and a cursor control module 105. The modules 101-105 include computerized codes in the form of one or more programs that are stored in the storage 11 or other storage mediums of the display device 100. The computerized codes include computer-readable program codes (instructions) that are executed by the processor 12 to provide functions for the display device 1. The storage 11 may be a cache or a dedicated memory, such as an erasable programmable read only memory (EPROM), a hard disk drive (HDD), or a flash memory. In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

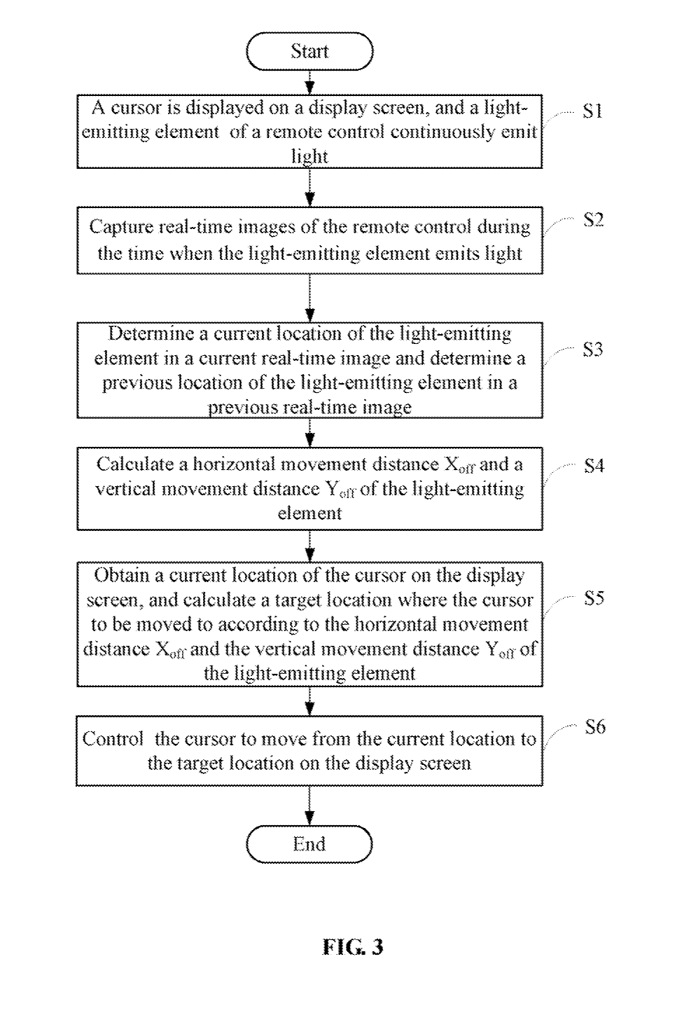

FIG. 3 is flowchart of one embodiment of a cursor control method for controlling the cursor displayed on the display screen 13 using the functional modules of cursor control system 10 of FIG. 2. Depending on the embodiment, additional steps may be added, others removed, and the ordering of the steps may be changed.

In step S1, when cursor control button 21 is pressed, the cursor is displayed on the display screen 13, and the light-emitting element 20 of the remote control 200 continuously emits light. In the embodiment, the cursor is displayed at a predetermined location of the display screen 13 (e.g., geometry center of the display screen 13) when the cursor control button 21 is pressed.

In step S2, the image capturing module 101 controls the image capturing device 110 to capture real-time images of the remote control 200 during the time when the light-emitting element 20 emits light. In the embodiment, the image capturing module 101 controls the image capturing device 110 to capture images at regular time intervals (e.g., every 0.5 seconds).

In step S3, the image analysis module 102 analyzes the captured images to determine a current location Pₖ₊₁(Xₖ₊₁, Yₖ₊₁) of the light-emitting element 20 in a current real-time image of the remote control 200 and to determine a previous location Pₖ(Xₖ, Yₖ) of the light-emitting element 20 in a previous real-time image of the remote control 200. In the embodiment, both the current location Pₖ₊₁(Xₖ₊₁, Yₖ₊₁) and the previous location Pₖ(Xₖ, Yₖ) represent coordinates of the light-emitting element 20 in the current real-time image and the previous real-time image. The image analysis module 102 converts the current mage of the remote control 200 into a first grey image, and then calculates a pixel which has a maximum brightness value of the first grey image. The location of the calculated pixel of the first grey image is determined to be the current location Pₖ₊₁(Xₖ₊₁, Yₖ₊₁) of the light-emitting element 20 in the current real-time image. In the same manner, the image analysis module 102 converts the previous real-time image of the remote control 200 into a second grey image, and then calculates a pixel which has a maximum brightness value of the second grey image. The location of the calculated pixel of the second grey image is determined to be the previous location Pₖ(Xₖ, Yₖ) of the light-emitting element 20 in the previous real-time image.

In step S4, the calculation module 103 calculates a horizontal movement distance X_{off} and a vertical movement distance Y_{off} of the light-emitting element 20 according to the current location Pₖ₊₁(Xₖ₊₁, Yₖ₊₁) and the previous location Pₖ(Xₖ, Yₖ) of the light-emitting element 20, where X_{off}=Xₖ₊₁−Xₖ, Y_{off}=Yₖ₊₁−Yₖ.

In step S5, the cursor location determination module 104 obtains a current location C₀(X′₀, Y′₀) of the cursor on the display screen 13, and calculates a target location C₁(X′₁, Y′₁) where the cursor to be moved to according to the horizontal movement distance X_{off} and the vertical movement distance Y_{off} of the light-emitting element 20. In the embodiment, the target location C₁(X′₁, Y′₁) is calculated according to the formula of: X′₁=X′₀+S₁×X_{off}, Y′₁=Y′₀+S₂×Y_{off}, where S₁ is a first predetermined coefficient, S₂ is a second predetermined coefficient. The coefficients S₁ and S₂ are predetermined according to a resolution of the display screen 13 and a resolution of the image capturing device 110. For example, if the resolution of the display screen is P₁×Q₁ and the resolution of the image capturing device is P′₁×Q′₁, the coefficient S₁ is equal to a ratio of P₁ to P′₁ and the coefficient S₂ is equal to a ratio of Q₁ to Q′₁.

In step S6, the cursor control module 105 controls the cursor to move from the current location C₀(X′₀, Y′₀) to the target location C₁(X′₁, Y′₁) on the display screen 13.

When the cursor is moved to the target location C₁(X′₁, Y′₁), the user can operate the buttons of the remote control 200 to select a corresponding option displayed on the display screen 13 where the cursor is located, thereby controlling the display device 100 to perform a corresponding function. Thus, the user can control the movements of the cursor by moving the remote control 100, which is more convenient for the user to control the display device 100 using the remote control 200.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A cursor control method of a display device having an image capturing device and a display screen, the display device being controlled by a remote control having a light-emitting element, the method comprising:
controlling the image capturing device to capture real-time images of the remote control during a time when the light-emitting element emits light;
determining a current location Pₖ₊₁(Xₖ₊₁, Yₖ₊₁) of the light-emitting element in a current real-time image of the remote control and determining a previous location Pₖ(Xₖ, Yₖ) of the light-emitting element in a previous real-time image of the remote control;
calculating a horizontal movement distance X_{off} and a vertical movement distance Y_{off} of the light-emitting element according to the current location Pₖ₊₁(Xₖ₊₁, Yₖ₊₁) and the previous location Pₖ(Xₖ, Yₖ) of the light-emitting element;
obtaining a current location C₀(X′₀, Y′₀) of a cursor displayed on the display screen, and calculating a target location C₁(X′₁, Y′₁) where the cursor to be moved to according to the horizontal movement distance X_{off} and the vertical movement distance Y_{off} of the light-emitting element; and
controlling the cursor to move from the current location C₀(X′₀, Y′₀) to the target location C₁(X′₁, Y′₁) on the display screen.

2. The method according to claim 1, wherein the step of analyzing the captured images comprising:
converting the current image of the remote control into a first grey image, and calculating a pixel which has a maximum brightness value of the first grey image, where a location of the calculated pixel of the first grey image is determined to be the current location Pₖ₊₁(Xₖ₊₁, Yₖ₊₁) of the light-emitting element in the current real-time image; and
converting the previous real-time image of the remote control into a second grey image, and calculating a pixel which has a maximum brightness value of the second grey image, where a location of the calculated pixel of the second grey image is determined to be the previous location Pₖ(Xₖ, Yₖ) of the light-emitting element in the previous real-time image.

3. The method according to claim 1, wherein the horizontal movement distance X_{off} and the vertical movement distance Y_{off} of the light-emitting element is calculated according to a formula of: X_{off}=Xₖ₊₁−Xₖ, Y_{off}=Yₖ₊₁−Yₖ.

4. The method according to claim 1, wherein the target location C₁(X′₁, Y′₁) is calculated according to a formula of: X′₁=X′₀+S₁×X_{off}, Y′₁=Y′₀+S₂×Y_{off}, where S₁ is a first predetermined coefficient, S₂ is a second predetermined coefficient.

5. The method according to claim 4, wherein the coefficients S₁ and S₂ are predetermined according to a resolution of the display screen and a resolution of the image capturing device.

6. The method according to claim 5, wherein the resolution of the display screen is P₁×Q₁ and the resolution of the image capturing device is P′₁×Q′₁; the coefficient S₁ is equal to a ratio of P₁ to P′₁ and the coefficient S₂ is equal to a ratio of Q₁ to Q′₁.

7. The method according to claim 1, wherein the remote control comprising a cursor control button; the light-emitting element continuously emits light and the cursor is displayed at a predetermined location on the display screen, when the cursor control button is pressed.

8. The method according to claim 1, wherein the display device is a high definition television (HDTV), a digital TV, a network TV, or a display of a computer.

9. The method according to claim 1, wherein the light emitted by the light-emitting element is captured by the image capturing device.

10. A display device controlled by a remote control having a light-emitting element, comprising:
a display screen;
an image capturing device;
a processor; and
one or more programs executed by the processor, to perform a method of:
controlling the image capturing device to capture real-time images of the remote control during a time when the light-emitting element emits light;
determining a current location Pₖ₊₁(Xₖ₊₁, Yₖ₊₁) of the light-emitting element in a current real-time image of the remote control and determining a previous location Pₖ(Xₖ, Yₖ) of the light-emitting element in a previous real-time image of the remote control;
calculating a horizontal movement distance X_{off} and a vertical movement distance Y_{off} of the light-emitting element according to the current location Pₖ₊₁(Xₖ₊₁, Yₖ₊₁) and the previous location Pₖ(Xₖ, Yₖ) of the light-emitting element;
obtaining a current location C₀(X′₀, Y′₀) of a cursor displayed on the display screen, and calculating a target location C₁(X′₁, Y′₁) where the cursor to be moved to according to the horizontal movement distance X_{off} and the vertical movement distance Y_{off} of the light-emitting element; and
controlling the cursor to move from the current location C₀(X′₀, Y′₀) to the target location C₁(X′₁, Y′₁) on the display screen.

11. The display device according to claim 10, wherein the step of analyzing the captured images comprising:
converting the current image of the remote control into a first grey image, and calculating a pixel which has a maximum brightness value of the first grey image, where a location of the calculated pixel of the first grey image is determined to be the current location Pₖ₊₁(Xₖ₊₁, Yₖ₊₁) of the light-emitting element in the current real-time image; and
converting the previous real-time image of the remote control into a second grey image, and calculating a pixel which has a maximum brightness value of the second grey image, where a location of the calculated pixel of the second grey image is determined to be the previous location Pₖ(Xₖ, Yₖ) of the light-emitting element in the previous real-time image.

12. The display device according to claim 10, wherein the horizontal movement distance X_{off} and the vertical movement distance Y_{off} of the light-emitting element is calculated according to a formula of: X_{off}=Xₖ₊₁−Xₖ, Y_{off}=Yₖ₊₁−Yₖ.

13. The display device according to claim 10, wherein the target location C₁(X′₁, Y′₁) is calculated according to the formula of: X′₁=X′₀+S₁×X_{off}, Y′₁=Y′₀+S₂×Y_{off}, where S₁ is a first predetermined coefficient, S₂ is a second predetermined coefficient.

14. The display device according to claim 13, wherein the coefficients S₁ and S₂ are predetermined according to a resolution of the display screen and a resolution of the image capturing device.

15. The display device according to claim 14, wherein the resolution of the display screen is P₁×Q₁ and the resolution of the image capturing device is P′₁×Q′₁; the coefficient S₁ is equal to a ratio of P₁ to P′₁ and the coefficient S₂ is equal to a ratio of Q₁ to Q′₁.

16. The display device according to claim 10, wherein the remote control comprising a cursor control button; the light-emitting element continuously emits light and the cursor is displayed at a predetermined location on the display screen, when the cursor control button is pressed.

17. The display device according to claim 10, wherein the display device is a high definition television (HDTV), a digital TV, a network TV, or a display of a computer.

18. The display device according to claim 10, wherein the light emitted by the light-emitting element is captured by the image capturing device.
